(19) United States
(12) Patent Application Publication
(10) Pub. No.: US 2025/0045550 A1
(43) Pub. Date: Feb. 6, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: NAOYUKI NISHIKAWA, Kanagawa (JP)

(21) Appl. No.: 18/783,606

(22) Filed: Jul. 25, 2024

(30) Foreign Application Priority Data
Aug. 2, 2023 (JP) 2023-126197

(51) Int. Cl. G06K 15/02

(52) U.S. Cl. CPC G06K 15/1861; G06K 15/1857; G06K 15/1859

(57) ABSTRACT

The present disclosure allows for efficient use of a memory in image processing to generate image data from printing data. Classification is performed based on memory usage characteristics in the unit of processing module or the unit of task or subtask. The memory usage characteristics are characterized by items: a required memory amount allocated at one time; allocation frequency for each required memory amount; and lifetime. The memory usage characteristics of processing modules are collected to perform cluster analysis, and the processing modules are classified into classes. Then, based on the memory usage characteristics of the processing modules classified as the same class, a design parameter of a memory allocator of high memory usage efficiency is obtained for each class. The memory allocator to which the design parameter obtained for each class is set is applied as the memory allocator common to the processing modules classified as the same class.

### BACKGROUND

### Field

The present invention relates to an image processing technique to generate image data from printing data.

### Description of the Related Art

Heretofore, there has been a generally and widely used rendering method in which outline information (also referred to as edge information) of a graphic is extracted from coordinate information and the like that the graphic has for drawing of the graphic, and image data is generated based on the outline information. In general, it is essential for the rendering processing to be able to continuously execute high-speed drawing processing. However, it is not easy to implement this because the time actually required for the rendering processing is changed depending on the type and the number of the graphics.

FIG. 1 is a schematic view describing an operation in a case of parallel processing to speed up RIP processing. In a case where there are a graphic 1 and a graphic 2, the graphics are processed by a thread-1 and a thread-2 that are independent and different from each other. Therefore, edge data of the two graphics are extracted concurrently, and pieces of painting information inside outlines of the graphics are extracted concurrently by color information extraction processing. The extracted edge data and color information are used to perform data synthesis processing by a thread-3. However, in a case where the core number is increased according to an increase of the parallel processing number, it hinders an access to a common memory in a multiprocessor system in which a main memory is shared with multiple processors, and the processing efficiency of the entire system is decreased.

Japanese Patent Laid-Open No. 2009-87335 proposes a multiprocessor system that uses a loosely coupled multiprocessor in which multiple processors each include an independent main memory, latency is short, and a processing load of each processor is relatively small.

However, even with the technique described in Japanese Patent Laid-Open No. 2009-87335, in some cases, a memory usage amount is increased due to the concurrent execution of different types of processing by parallel processing, and a working memory is used up. In this case, the solution has to be releasing of a free region (fragmentation) of a small unit generated in an internal memory or releasing (garbage collection) of an unnecessary memory region of a substantial size. However, it is not easy to accurately predict the fragmentation, and it is difficult to secure a sufficient memory region by releasing the fragmentation. Additionally, there is a problem that the execution of the garbage collection decreases the processing speed.

### SUMMARY

The present invention is an image processing apparatus that generates image data by using multiple processing modules to process input data, including: a classification unit that classifies the multiple processing modules into multiple classes based on memory usage characteristics; and an applying unit that applies a common memory allocator to processing modules classified as the same class by the classification unit, the common memory allocator having a design parameter that is set based on the memory usage characteristics corresponding to the class.

Further features of the present disclosure will become apparent from the following description of exemplary embodiments with reference to the attached drawings.

### BRIEF DESCRIPTION OF THE DRAWINGS

FIG. 1 is a schematic view describing intermediate data generation processing (parallel processing);

FIG. 2 is a graph illustrating a state in which processing time is changed by input data;

FIG. 3 is a block diagram illustrating a configuration of a conventional printing system;

FIG. 4 is a schematic view describing a usage status of a memory in a conventional parallel processing system;

FIG. 5 is a block diagram illustrating a hardware configuration of an image processing apparatus in an embodiment 1;

FIG. 6 is a block diagram schematically describing a processing module to generate intermediate data in the embodiment 1;

FIG. 7A is a schematic view illustrating a relationship between the processing module and a memory allocator;

FIG. 7B is a schematic view illustrating the relationship between the processing module and the memory allocator;

FIG. 8 is a table illustrating a classification example of the memory allocator in the embodiment 1;

FIG. 9 is a flowchart describing recovery processing in the embodiment 1;

FIG. 10 is a configuration example of the memory allocator in a multithread mode in the embodiment 1;

FIG. 11 is a configuration example of the memory allocator in a single thread mode in the embodiment 1;

FIG. 12 is a schematic view describing a usage status of a memory in the embodiment 1;

FIG. 13A is a diagram illustrating a histogram of a required memory amount in a different processing module in an embodiment 2;

FIG. 13B is a diagram illustrating a histogram of a required memory amount in a different processing module in the embodiment 2;

FIG. 13C is a diagram illustrating a classification example of the memory allocator;

FIG. 14A is a configuration example of the memory allocator applied to a classified processing module group in the embodiment 2; and

FIG. 14B is a configuration example of the memory allocator applied to a classified processing module group in the embodiment 2

### DESCRIPTION OF THE EMBODIMENTS

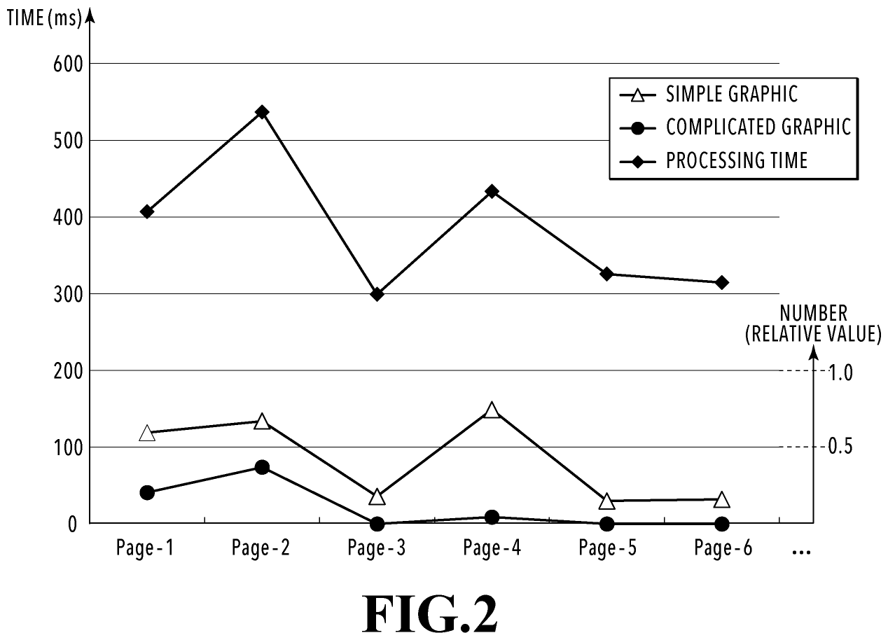

FIG. 2 is a graph illustrating a change of the above-mentioned rendering processing time. In FIG. 2, a vertical axis indicates the processing time (milliseconds) while a horizontal axis indicates a page of a print job. In the example illustrated in FIG. 2, in a first page, it takes about 400 milliseconds to complete the processing, and in a second page, time of about 550 milliseconds is consumed. In FIG. 2, a line graph changed according to a triangular point indicates the number (a relative value) of simple graphics included in the job, and a line graph changed according to a circular point indicates the number (a relative value) of graphics other than the simple graphics (for the sake of convenience, called complicated graphics). The simple graphics are simple graphics such as a rectangle and a triangle, and the complicated graphics include a polygon such as a graphic having five or more vertices. It can be seen that both the case of including the simple graphic and case of including the complicated graphic have a substantially similar correlation to the graphic object number although there is a difference in the data processing time.

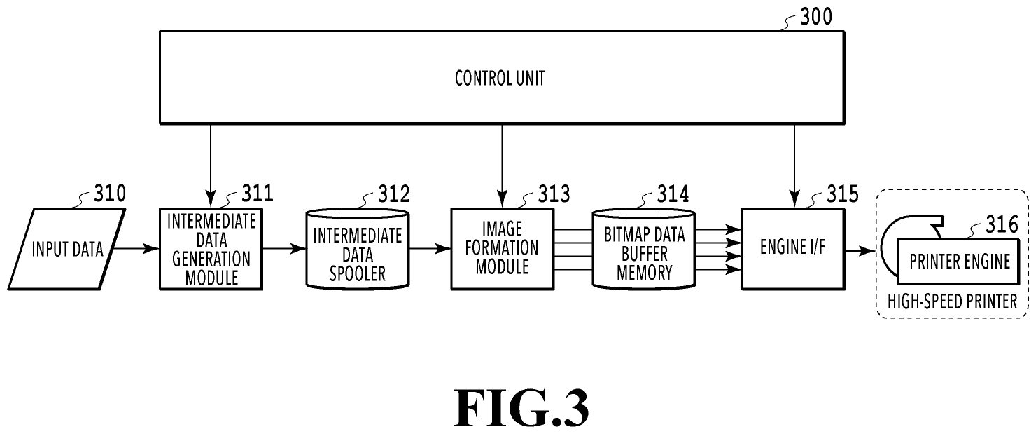

FIG. 3 is a diagram illustrating a configuration of a conventional image processing apparatus. In the conventional image processing apparatus, once printing is started, input data (PDL data) 310 is transmitted to an intermediate data generation module 311, and the intermediate data generation module 311 performs PDL interpretation, drawing processing (outline extraction), and the like. Then, graphics data and the like in each page is converted into data (hereinafter, called intermediate data) in a format appropriate for subsequent image generation processing. The intermediate data may also be referred to as a display list or the like. The intermediate data is temporarily stored in an intermediate data spooler 312 and thereafter transferred to a subsequent image generation module 313.

The image generation module 313 deploys pixel data to a memory based on information of the intermediate data. The pixel data deployed to the memory is temporarily stored in a bitmap data buffer memory 314, and thereafter, the pixel data is transferred to a printer engine 316 by way of an engine interface (I/F) 315. Note that, the intermediate data generation module 311, the image generation module 313, and the engine I/F 315 are controlled by a control unit 300.

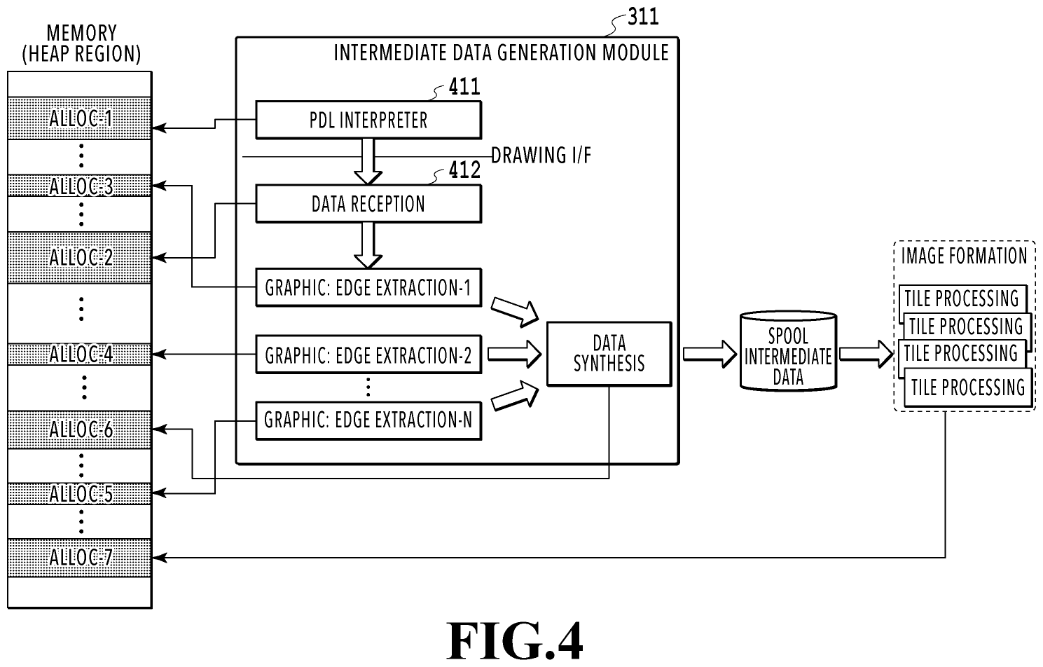

FIG. 4 is a schematic view describing a usage mode of a general memory in a case where the intermediate data generation module 311 operates. A PDL interpreter 411 uses a memory allocated to ALLOC-1, and a data reception unit 412 uses a memory region allocated to ALLOC-2. The threads by which the edges of the graphics are extracted use memory regions allocated to ALLOC-3, 4, 5, respectively, and a memory region allocated to ALLOC-6 is used for processing of data synthesis. In processing of generating image data after the intermediate data is generated, ALLOC-7 is used.

As described above, the processing speeds up with a configuration that allows for parallel processing of the RIP internal processing structure; however, in a case of a multicore processor, as the number of the usable cores is increased, a load on the memory is increased. Additionally, there is still a problem that, even in a case where the problem of the common memory is solved, the working memory is increased due to the concurrent execution of different types of processing by the parallel processing. In general, an installed memory amount is different depending on an operation environment; however, since the maximum value is fixed in any case, there is a problem that printing cannot be performed in a case where the working memory is used up. In the actual measurement, it is confirmed that there is a job including a great amount of images and graphics, and there is a case where the working memory exceeds the installed memory even in a general PC environment.

Even in a case where a great amount of the memory is consumed, there is still a case where it is possible to solve the problem by recovery processing to reduce the memory. In fact, there is a case where there is a released region inside even in a state in which the memory is depleted (or a case where there is a region that can be released, and the problem can be solved by releasing the memory in the timing). In addition to this, it is possible to increase some free regions by researching the state of the fragmentation in right time. However, it is not easy to predict or research the state of the fragmentation with high accuracy while the processing proceeds. Additionally, even if the research can be achieved, it is difficult to take effective measures because the state of the fragmentation is changed every second over time. As a similar approach, it is possible to consider execution of processing such as the garbage collection to a substantial region. However, the processing speed is significantly reduced in this case, and thus it is not a resolution to the problem.

Embodiments of the present invention are described below based on the drawings.

### Embodiment 1

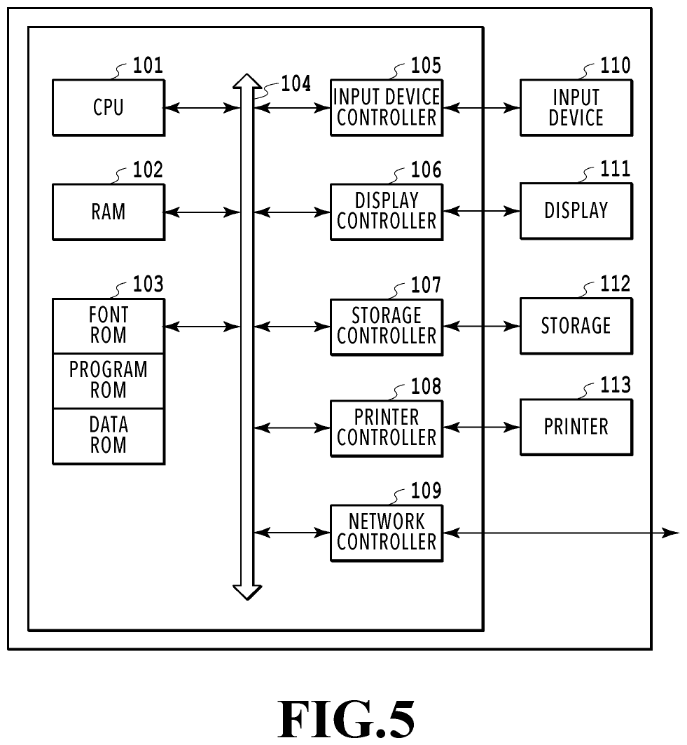

FIG. 5 is a diagram illustrating an example of a hardware configuration of an image processing apparatus.

A CPU 101 executes a program such as an OS and a general application loaded in a RAM 102 from a ROM 103 or a hard disk and implements a function of software and processing of a flowchart described later.

The RAM 102 functions as a main memory, a working area, and the like of the CPU 101. An input device controller 105 receives an input from an input device 110 such as a keyboard and a not-illustrated pointing device. A display controller 106 controls displaying on a display 111. A storage controller 107 controls an access to a storage 112 such as the hard disk (HD) and a flexible disk (FD) that store a boot program, various applications, font data, a user file, and the like. A printer controller 108 controls exchanging of a signal with a connected printer 113. A network controller 109 is connected to a network and executes control processing of communication with another device connected to the network.

Note that, in the present embodiment, it is described that the function of the image processing apparatus described below is implemented by the software; however, each function may be implemented in the image processing apparatus by dedicated hardware.

Note that, the CPU 101 of the present embodiment is a multicore CPU. The image processing apparatus may include multiple CPUs or processors.

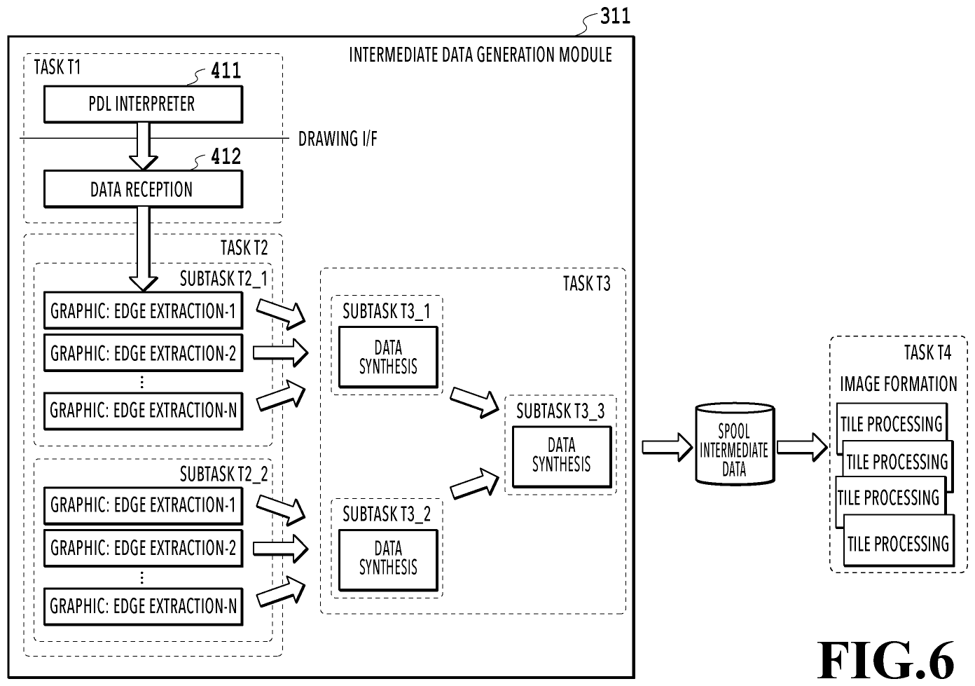

FIG. 6 is a block diagram schematically describing a processing module that generates intermediate data in the present embodiment 1. The processing module is formed of multiple processing modules that generate the intermediate data by performing various types of processing on the inputted data (the printing job). As illustrated in FIG. 6, a processing module group in the present embodiment is broadly divided and classified into four tasks T1 to T4 such that the tasks T1 to T4 are each operated time-independently. Additionally, a subtask is additionally allocated to the inside of each of the tasks T2 and T3.

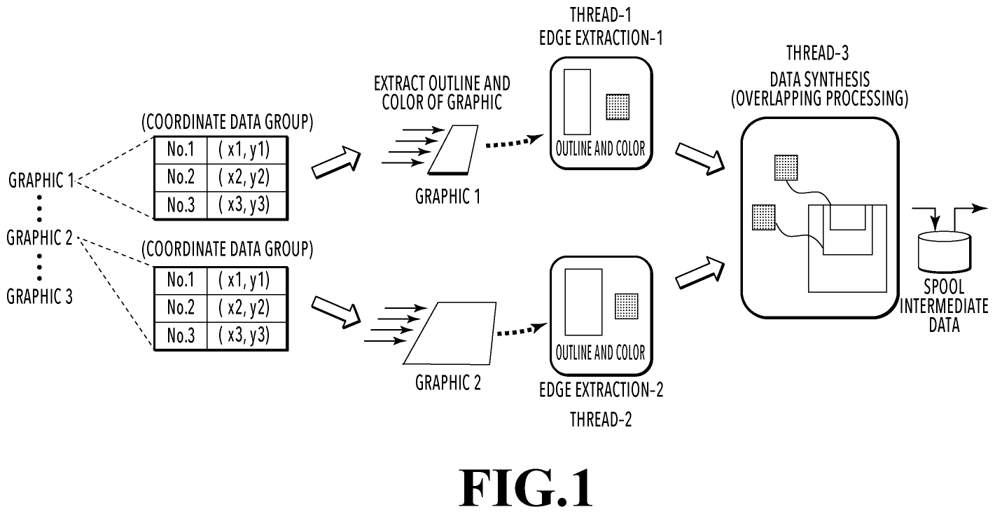

Each task exists to execute parallelization processing as illustrated in FIG. 1, and each task is formed of multiple processing module groups (function groups). In order to operate the processing module groups, it is necessary to secure a memory to generate an instance (an information area storing operation conditions, setting information, and the like) for each function. Alternatively, it is necessary to secure a memory for the purpose of transferring processing data (information on the image and the object). The memory secured for the processing module has a different role depending on the intended use; for this reason, the requested size of the memory is various. Additionally, there are a region that shares the memory and a region that occupies the memory. In the region that shares the memory, there are additionally a region that is shared on the premise of parallel processing and a region that is not on the premise of the parallel processing. Moreover, it is important for the above-described processing module group to use the memory efficiently, and in order to prioritize the high-speed execution of processing, the processing module group operates while allowing the memory fragmentation and the like to a certain degree. Furthermore, in the present embodiment, processing like the garbage collection that takes time and decreases the processing speed is not executed. Furthermore, the above-described memory that is secured for the module group is all allocated to a memory region (a physical memory) that can be executed at high speed.

Operations of the tasks (T1 to T4) are described in further detail below.

The task T1 is also referred to as a PDL task as another name and performs processing as a PDL interpretation unit, a drawing IF (DRAWING-IF) unit, and a data reception unit. As the PDL interpretation unit, PDL data including a printing instruction is received, and parsing of each page is executed for a printing start page to the last page. As the drawing IF unit, a drawing command is generated based on a parsing result in the PDL interpretation unit and outputted to the data reception unit. As the data reception unit, the received drawing command is stored in a queue (a standby memory) as needed.

The task T2 is an edge processing module that takes out the drawing command stored in the queue as needed and activates the internal subtask T2 to perform processing. In a case where the taken out drawing command is a command of graphic drawing, the subtask T2 executes processing to extract edge information (edge data) of the graphic and outputs the edge information to the subsequent task T3.

The task T3 is a systhesis processing module that receives the edge data outputted from the task T2 and activates the internal subtask T3 to sequentially perform systhesis processing according to a state of each edge data. The task T3 recursively executes the systhesis processing on the received edge data, generates the final intermediate data for each page in the form of a tile, and stores the intermediate data in an intermediate data spooler.

The task T4 takes out the intermediate data from the intermediate data spooler, performs the image generation processing for each tile, and outputs the image data (pixel data).

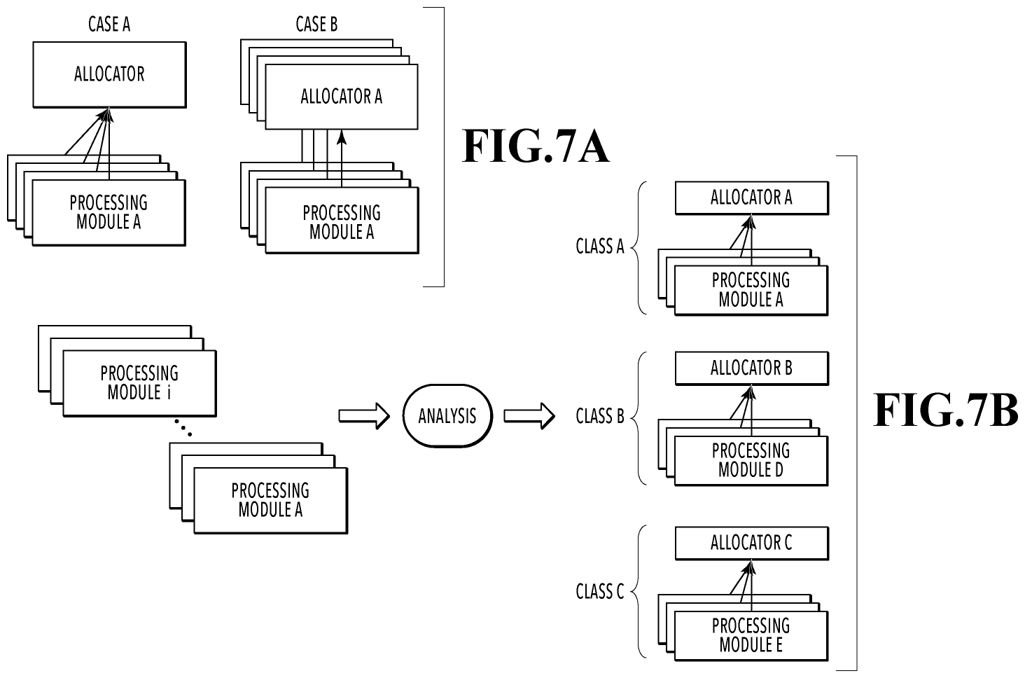

Next, a configuration of the memory allocator is described with reference to FIGS. 7A and 7B.

A case A illustrated in FIG. 7A is a general mode in which the memory allocator is used from multiple modules. On the other hand, a case B is a mode in which each module uses an independent memory allocator. However, in the case B, the number of the memory allocators is increased, and a wasted free region is generated in a management region of each memory allocator; for this reason, it is not preferable in terms of the usage efficiency of the memory.

Therefore, in the present embodiment 1, as illustrated in FIG. 7B, classification is performed based on memory usage characteristics (an allocation pattern) in the unit of processing module or the unit of task or subtask. In the present embodiment, the memory usage characteristics are characterized by items: a required memory amount allocated at one time (byte number); allocation frequency for each required memory amount (allocation number of times); and lifetime (time from allocation to release). The multiple processing modules are classified into multiple classes by collecting the memory usage characteristics of the multiple processing modules and performing cluster analysis. Then, based on the memory usage characteristics of the processing modules classified as the same class, a design parameter of the memory allocator of high memory usage efficiency is obtained for each class. The memory allocator to which the design parameter obtained for each class is set is applied as the memory allocator common to the processing modules classified as the same class. In order to obtain the design parameter of high memory usage efficiency, for example, a block size of the memory allocator may be set smaller as the required memory amount is smaller and the lifetime is shorter in one allocation. On the other hand, the block size of the memory allocator may be set greater as the required memory amount is greater and the lifetime is longer.

Basically, memory alignment may be set great such as “32” or “64”; however, in a case where there is a tendency that the requested size is varied, the memory alignment may be set small such as “16” to enhance the usage efficiency. The analysis and the classification of the memory usage characteristics of each processing module and the determination of the design parameter of the memory allocator corresponding to the classified class may be executed experimentally in a timing in which the processing module is designed and implemented. Note that, an analysis unit may be prepared in the image processing apparatus, and the analysis and the classification of the memory usage characteristics of each processing module and the determination of the design parameter of the memory allocator corresponding to the classified class may be executed as needed.

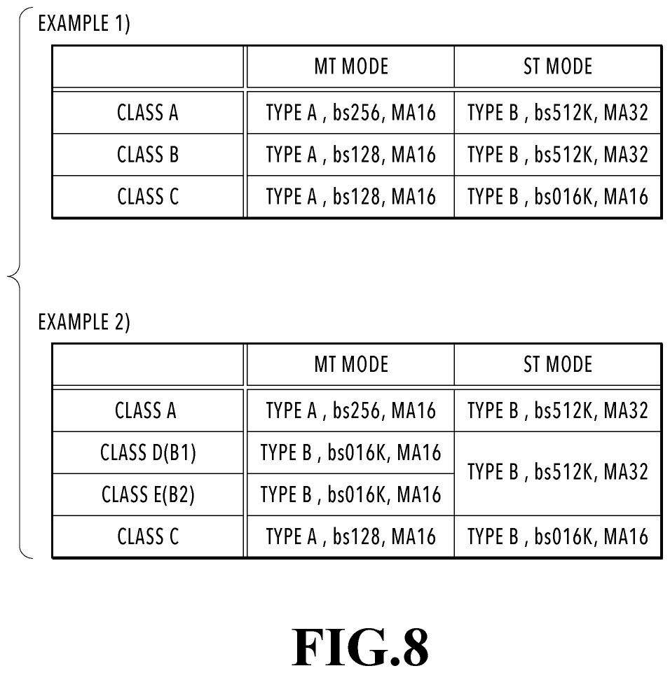

FIG. 8 is a schematic view describing an example of the class classification.

In the present embodiment, the RIP can operate in both the multithread mode (MT mode) for parallel processing of multiple tasks and single thread mode (ST mode) for processing of each task and has a configuration that allows for switching between the two operation modes. The inside of each processing module has a common module configuration in both the MT mode and ST mode, and each processing module has a configuration that allows for uniform classification.

A configuration indicated in a table in an example 1 is a simple configuration example, and the class classification in the MT mode and the class classification in the ST mode are the same.

On the other hand, a configuration indicated in a table in an example 2 shows that the class classification in the MT mode and the classification in the ST mode are slightly different from each other. In the MT mode, different processing modules are classified for a class D and a class E, but in the ST mode, the same processing module is classified for the class D and the class E, and the classification configuration is different between the MT mode and the ST mode.

In the memory allocator applied to each processing module classified into the corresponding class, each design parameter is optimized individually. A type A has a lock function by MUTEX (or semaphore), but the type B does not have this function. Additionally, any one of the sizes of 512 KB, 256 KB, and 128 KB is set as the block size (BS). As the memory alignment (MA), 32 bit or 16 bit is designated.

The above-described classification operation may be executed in a timing in which the processing module is designed and implemented, or a classification unit may be prepared in the image processing apparatus and executed as needed.

Thus, in the present embodiment, the memory allocators having different design parameters, respectively, are allocated to the multiple processing module groups classified into predetermined multiple classes.

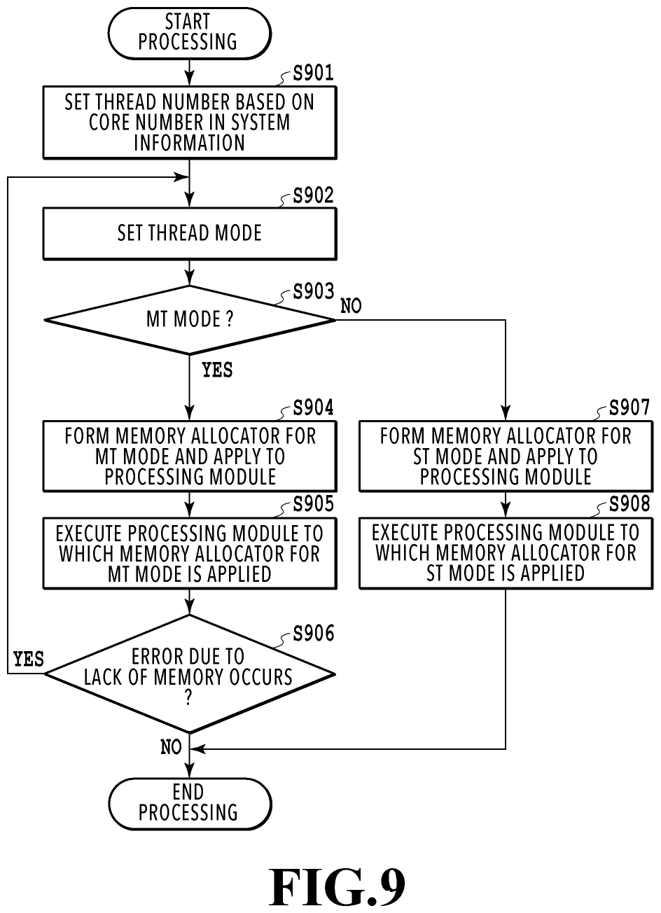

FIG. 9 is a flowchart describing a basic operation in the present embodiment.

The processing is started once the printing job is inputted, and the operation in the first time is in the MT mode. As indicated by the flowchart in FIG. 9, in the present embodiment, although the operation is basically in the MT mode, in a case where an error occurs due to a lack of the memory capacity and the like, the ST operation is also supported as recovery processing, and the configuration of the memory allocator is changed.

Switching between the MT mode and the ST mode is schematically described.

In S901, the thread number of the same number of the usable core number is set based on system information, that is, for example, “4” is set as the thread number if four cores are usable.

In S902, the thread mode is set according to the set thread number. If there are multiple threads, the thread mode is set to the MT mode, and if there is one thread, the thread mode is set to the ST mode.

In S903, if the thread mode is the MT mode, the process proceeds to S904, and if the thread mode is the ST mode, the process proceeds to S907.

In S904, the memory allocator for the MT mode applied to the processing module that performs the PDL processing, the image generation processing, and the like is formed.

In S905, the processing module to which the memory allocator for the MT mode is applied is executed.

In S906, during the execution of the processing module to which the memory allocator for the MT mode is applied, it is determined whether there occurs an error due to a lack of the memory such as a heavy printing job and the consumed memory exceeds a set threshold. If there occurs no error, all the processing modules are executed, and the series of processing ends. If it is determined that there occurs an error, “1” is set as the thread number, and the process returns to S902.

In a case where the process returns from S906 to S902, in S902, the thread mode is switched to the ST mode, and the process proceeds to S907 by way of S903.

In S907, the already-existing memory allocator for the MT mode is discarded, and the memory allocator for the ST mode applied to the processing module that is not processed in S905 is formed.

In S908, the processing module that is not processed in S905 and to which the memory allocator for the ST mode is applied is executed, all the processing modules are executed, and the series of processing ends.

Note that, although it is determined whether there occurs an error due to a lack of the memory in S906 in the present embodiment, it may be determined whether the free capacity of the memory is equal to or greater than a predetermined threshold, and the thread mode may be changed before an error occurs.

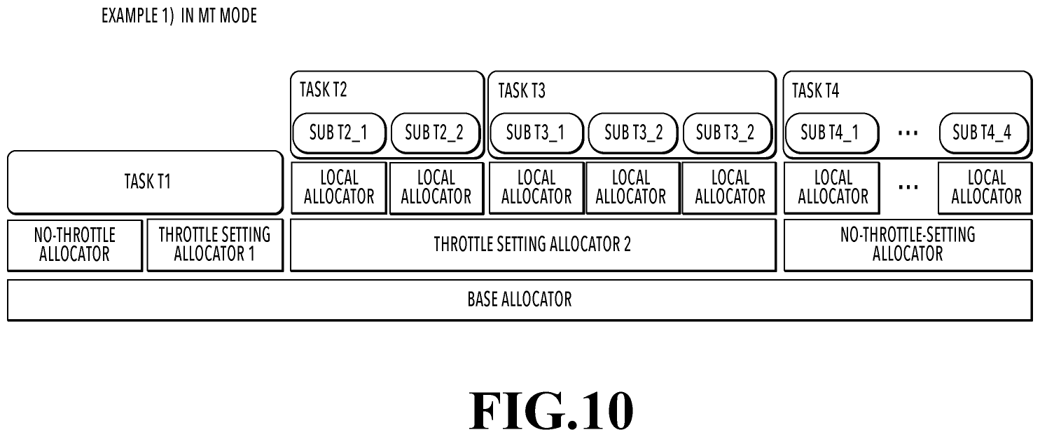

FIG. 10 is a diagram describing the memory allocator for the multithread mode. As the allocator for the MT mode, various types of local allocators are prepared from a base allocator by way of a throttle setting allocator. The throttle setting allocator herein is the memory allocator to which a threshold of the maximum secured memory amount is set. For example, in a case where the threshold of the maximum secured memory amount is set to 400 MB for the throttle setting allocator, it is possible to limit the total amount of the memory allocation to the memory allocator subsequent to the throttle setting allocator. In the present embodiment 1, the memory allocator is formed to set independently for each application (task) to be used.

Note that, during the MT mode operation, exclusive control such as a lock for the data object using the semaphore is required as needed for the data object stored in a common region in the memory to which the multiple processing modules can access. However, in a case where the data object stored in the shared region can be independently processed by processing of a band that is a predetermined unit processing region, the exclusive control of the data object can be omitted by separating the memory allocators themselves for each band. The suppressed number of the exclusively controlled data objects contributes greatly to the improvement of the processing speed.

In addition, in the image data generation processing, the processing is separated for each tile, and there is a tendency of higher independency of each data; for this reason, as illustrated in FIG. 10, the memory allocators of the core numbers, the tasks T1 to T4, are prepared, and the processing is executed in parallel.

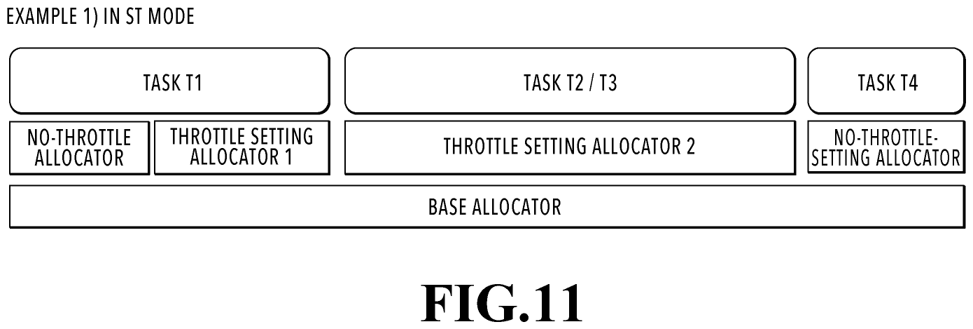

FIG. 11 is a diagram describing the memory allocator for the single thread mode. In the MT mode, a memory allocator design that improves the processing speed by parallel execution is applied; however, in the ST mode, a memory allocator design that reduces the memory consumption amount is applied. Therefore, in the ST mode, a configuration to increase the common region to suppress overhead of the memory allocator as much as possible is applied. Additionally, a configuration in which a journal mode can be used in the memory allocator for the intermediate data generation processing that consumes a great amount of memory is applied. In a case where the journal mode is used, a prediction value of the latest memory consumption amount is calculated from the history of data object input. Then, in a case where it is determined that the calculated prediction memory amount becomes smaller than the predetermined threshold and the memory is depleted concurrently with the securing of a reserved region, measures for the memory depletion such as switching the processing mode are taken in the early stage.

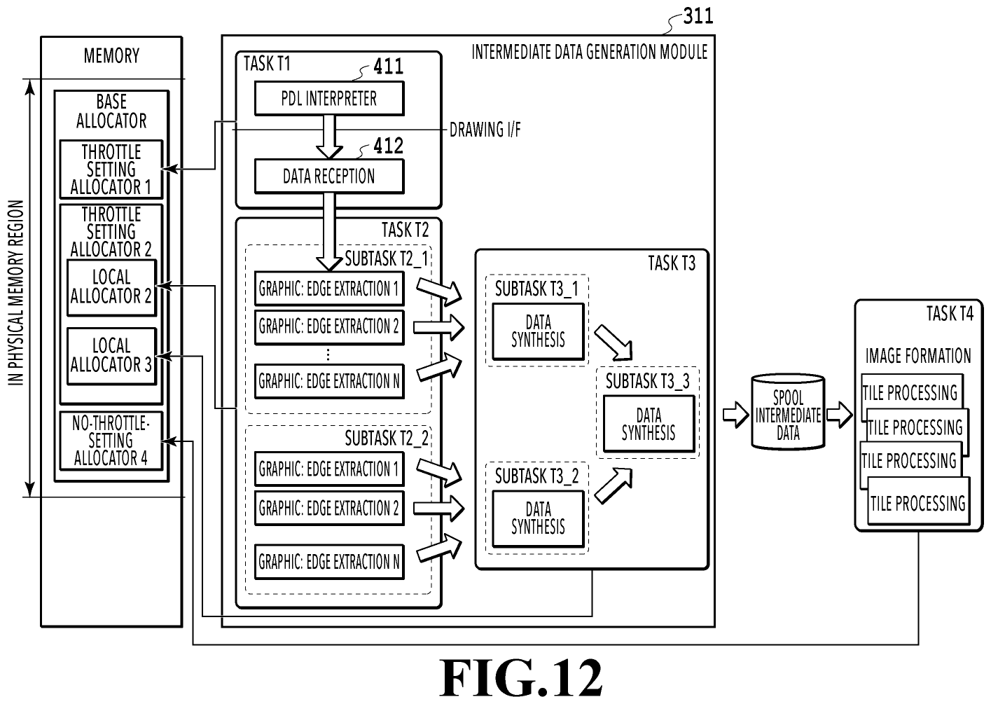

FIG. 12 is a schematic view describing a usage mode of the memory during the intermediate data generation module operation in the present embodiment 1. In the present embodiment 1, all the memory allocators are formed on the base allocator. This region is basically formed to perform allocation to the physical memory that can be executed at high speed. The task T1 is in charge of the processing such as the PDL interpretation and uses the memory allocated to a throttle setting allocator 1. The task T2 is in charge of the edge processing, and the task T3 is in charge of the edge systhesis processing. The tasks T2 and T3 use the memory regions allocated to a local allocator 2 and a local allocator 3, respectively, and the memory regions are formed on a throttle setting allocator 2. The task T4 that generates the image data after the intermediate data is generated is formed to use a no-throttle-setting allocator 4 to which no threshold of the maximum secured memory amount is set.

Thus, with the common memory allocator being set for the tasks having similar behavior, it is unnecessary to set the common management information to the individual memory allocator, and it is possible to reduce the management region. Additionally, with the tasks of similar required memory amounts being combined, it is possible to reduce the memory region allocated as a buffer for the class in which the variation of the required memory amount in the unit of class is small.

### Embodiment 2

Another embodiment other than the above-described embodiment is described below.

Although the embodiment 2 has a similar configuration as that of the above-described embodiment 1, an analysis method of the pattern of the memory allocation by each processing module (or in the unit of task or subtask) described in FIGS. 7A and 7B is different. Simple description is given below with reference to the drawings.

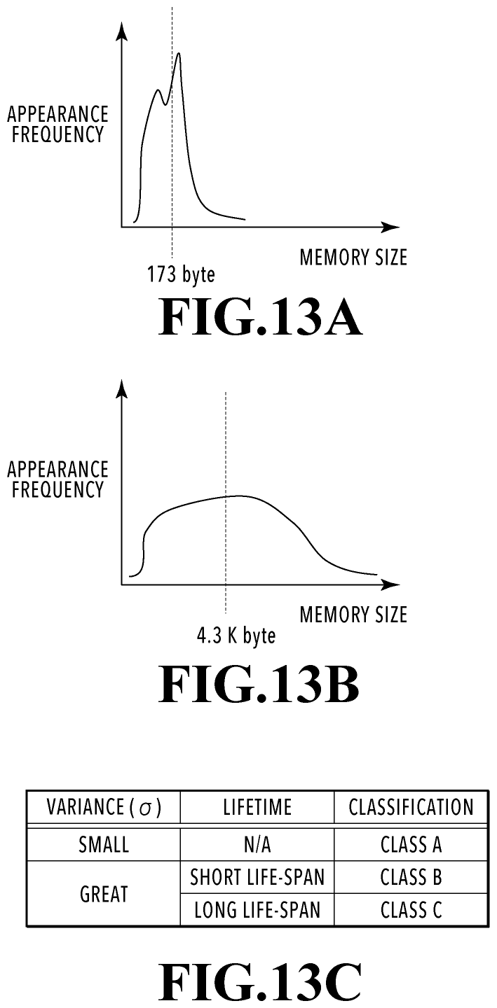

FIGS. 13A to 13C are diagrams illustrating a histogram of the required memory amount in different processing modules and a classification example of the memory allocator. In the histogram, a requested memory size (the required memory amount) is plotted on a horizontal axis, and an appearance frequency of each required memory amount is plotted on a vertical axis. FIG. 13A is a histogram illustrating the appearance frequency of a not-illustrated processing module A group for each required memory amount. In this example, the required memory amount in the average appearance frequency of the processing module A group is 173 byte. In this case, it can be seen that the requested memory is small. On the other hand, FIG. 13B is a histogram illustrating the appearance frequency of a not-illustrated module B group for each required memory amount. In this example, the required memory amount in the average appearance frequency of the processing module B group is 4.3 Kbyte, and it can be seen that the variance of the required memory amount is greater than that of the module A group. With the class classification to which the lifetime of each memory is added in addition to the results of FIGS. 13A and 13B, it is possible to achieve classification into three classes as illustrated in a table in FIG. 13C. In a case of the module A group that has the tendency of small variance of the required memory amount, the block size of the memory allocator may be set close to the memory size in the average appearance frequency to enhance the usage efficiency (a class A). In a case of the module B group that has the tendency of great variance of the required memory amount, the memory allocator is further classified into a class B of a short lifetime of the memory, which means short life-span, and a class C of a long lifetime of the memory, which means long life-span. The concurrently required memory amount in a case of the short lifetime is less than the concurrently required memory amount in a case of the long lifetime; for this reason, it is possible to make the block size of the memory allocator smaller in the class B than the class C. With the classification as described above to optimize the block size of the memory allocator, it is possible to enhance the usage efficiency of the memory.

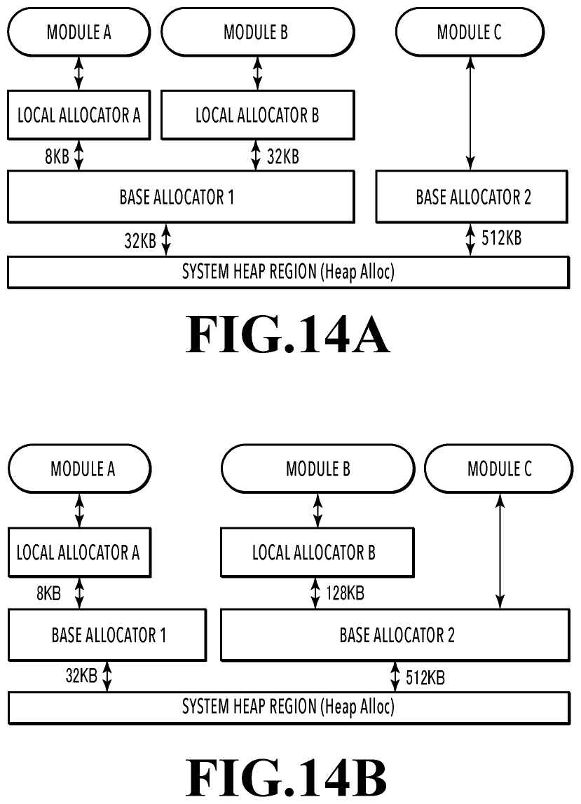

FIGS. 14A and 14B illustrate a configuration example of the memory allocator applied to the processing module group classified into the classes illustrated in FIG. 13C. For example, as illustrated in FIG. 14A, the memory allocators that operate according to the classes A, B, and C as illustrated in FIG. 13C are allocated to the processing modules A, B, and C. In FIG. 14A, two types of the base allocators (one is a base allocator 1 allocated in the unit of 32 KB from a heap region and the other is a base allocator 2 allocated in the unit of 512 KB) are prepared from the heap region on a system side. From the base allocator 1, a local allocator A that allocates the memory in the unit of 8 KB and a local allocator B that allocates the memory in the unit of 32 KB are further prepared to an upper layer. The processing module A group uses the local allocator A, and the processing module B group corresponding to the classification B in the table illustrated in FIG. 13C secures the memory from the local allocator B. On the other hand, a module C group that is a module group derived from the processing module B group and corresponds to the classification C in the table illustrated in FIG. 13C secures the memory directly from the base allocator 2. There may be considered multiple ideas for the classification pattern; therefore, for example, a configuration as illustrated in FIG. 14B that is different from the configuration illustrated in FIG. 14A may be applied.

### Other Examples

As other examples, is possible to consider setting of a small region (referred to as a working allocator) temporarily in a region of the memory allocator used by the tasks T2 and T3 in the memory allocator set in the MT mode. This working allocator is effective for information of a short lifetime that is immediately released, for example. Alternatively, it is possible to consider an idea to set a shared allocator dedicated for sharing the data between the tasks T2 and T3, for example. In addition, a configuration in which a boundary between a shared region and not-shared region is switched in the unit of data band in a Y direction or the unit of band in a Z direction (the drawing order) may be applied. Additionally, it is possible to consider an idea to use the memory allocator having the journal function also in the MT mode. In any case, it is possible to enhance the usage efficiency of the memory by analyzing the usage pattern according to the usage characteristics of the memory in each processing module and allocating the optimal memory allocators based on the usage patterns.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

In the present invention, it is possible to efficiently use a memory in image processing to generate image data from printing data.

This application claims the benefit of Japanese Patent Application No. 2023-126197 filed Aug. 2, 2023, which is hereby incorporated by reference wherein in its entirety.

1. An image processing apparatus that generates image data by using a plurality of processing modules to process input data, comprising:
a classification unit that classifies the plurality of processing modules into a plurality of classes based on memory usage characteristics; and
an applying unit that applies a common memory allocator to processing modules classified as the same class by the classification unit, the common memory allocator having a design parameter that is set based on the memory usage characteristics corresponding to the class.

2. The image processing apparatus according to claim 1, wherein
the memory usage characteristics includes at least one of a required memory amount in one allocation, allocation frequency for each required memory amount, and time from allocation to release.

3. The image processing apparatus according to claim 2, wherein
the design parameter includes a block size of the memory allocator, memory alignment, and a parameter indicating whether to control exclusively.

4. The image processing apparatus according to claim 3, wherein
the applying unit determines the design parameter based on an average and a variance of the required memory amount of each class.

5. The image processing apparatus according to claim 4, wherein
as the variance of the required memory amount of each class is smaller, the applying unit sets the block size of the memory allocator closer to the average of the required memory amount of each class.

6. The image processing apparatus according to claim 3, wherein
as the time from allocation to release of each class is shorter, the applying unit makes the block size of the memory allocator smaller.

7. The image processing apparatus according to claim 3, wherein
as the required memory amount of each class is smaller, the applying unit makes the block size of the memory allocator smaller.

8. The image processing apparatus according to claim 1, further comprising:
a measurement unit that measures the memory usage characteristics of each of the plurality of processing modules, wherein
the classification unit classifies the plurality of processing modules based on the memory usage characteristics measured by the measurement unit.

9. The image processing apparatus according to claim 1, wherein
in a case where an error occurs due to a lack of a memory in a case of applying a memory allocator for a multithread mode to the plurality of processing modules, the applying unit applies again a memory allocator for a single thread mode to the plurality of processing modules.

10. The image processing apparatus according to claim 1, wherein
in a case where a free capacity of the memory is equal to or greater than a predetermined threshold, the applying unit applies a memory allocator for a multithread mode to the plurality of processing modules, and in a case where the free capacity of the memory is smaller than the predetermined threshold, the applying unit applies a memory allocator for a single thread mode to the plurality of processing modules.

11. The image processing apparatus according to claim 1, wherein
the plurality of processing modules include an edge processing module that extracts edge information of a graphic included in the input data, a systhesis processing module that synthesizes the extracted edge information of each graphic, and an image generation module that generates data obtained by the systhesis processing as intermediate data in the form of a tile and generates image data from the intermediate data.

12. An image processing method to generate image data by using a plurality of processing modules to process input data, comprising:
classifying the plurality of processing modules into a plurality of classes based on memory usage characteristics; and
applying a common memory allocator to processing modules classified as the same class by the classifying, the common memory allocator having a design parameter that is set based on the memory usage characteristics corresponding to the class.

13. A non-transitory computer readable storage medium storing a program causing a computer to execute an image processing method to generate image data by using a plurality of processing modules to process input data, comprising:
classifying the plurality of processing modules into a plurality of classes based on memory usage characteristics; and
applying a common memory allocator to processing modules classified as the same class by the classifying, the common memory allocator having a design parameter that is set based on the memory usage characteristics corresponding to the class.
